(19) United States
(12) Patent Application Publication
(10) Pub. No.: US 2002/0129098 A1
(43) Pub. Date: Sep. 12, 2002

(54) LAN connection status display

(76) Inventors: Dennis Stone, Costa Mesa, CA (US); Ryan Tze, Irvine, CA (US)

Correspondence Address: PILLSBURY WINTHROP LLP, Suite 2800, 725 South Figueroa Street, Los Angeles, CA, 90017-5406, US

(21) Appl. No.: 09/799,984

(22) Filed: Mar. 6, 2001

(51) Int. Cl. G06F 15/173; G06F 15/16

(52) U.S. Cl. 709/203; 709/224

(57) ABSTRACT

A LAN connection monitoring system and method are provided. The system includes a plurality of LAN connection terminals for connecting the system to a plurality of workstations and transmitting binary signals between the system and the workstations. The system further includes a display for displaying activity information of LAN connection terminals, signal detection means for detecting any binary signal transmission at each of the LAN connection terminals, calculating means for calculating a transfer rate of the binary signal transmission at a LAN connection terminal, signal relaying means for relaying the detected binary signal transmission to the calculating means, and displaying means for displaying the calculated transfer rate and/or activity information on the display.

### BACKGROUND OF THE INVENTION

1. Field of the Invention

The present invention generally relates to the monitoring of local area networks. More specifically, the present invention relates to a system and method of monitoring and displaying status and activity of LAN connections on a display.

2. Discussion of the Related Art

The use of local area networks (LANs) to interconnect a number of computers and other types of digital systems has become common place in even small installations. Small businesses, the number of which has been estimated to be about 2.4 million in U.S. alone, routinely interconnect computers and other types of digital systems throughout their offices and use them to pass information back and forth and to share common printers, modems, and the like over the LAN. In addition to small businesses, it has become prevalent to set up LANs in remote workgroups and home environments.

The networks have been standardized to some degree to facilitate communications among the computers and other types of digital systems. Examples of the standards used are Ethernet and IEEE 802.3. More than one-half of the LANs in the United States employ the 10BASE-T standard for Ethernet-type LANs operating under the IEEE 803.2 protocol. Ethernet is the trademark for the Carrier Sensing Multiple Access/Collision Detection local area networking protocol developed by Digital Equipment Corporation, Xerox, and Hewlett-Packard. The 10BASE-T standard LAN transmits over low-cost, voice grade, unshielded twisted pair cabling. It connects using standard telephone technology with telephone-type plugs at the office wall and at the back panel of the computer. These telephone-type plugs are designated as “RJ45” in the industry.

Diagnostic routines and methods are commonly employed in LANs because the computers and other types of digital systems typically perform common tasks or missions on a resources allocation or distribution basis. In such an environment, the condition of the LAN and its ability to reliably transmit data between two computers, between two digital systems, or between a computer and a digital system is of critical importance. If a LAN connection is inoperative or malfunction, one must be able to sense it as soon as possible so that the problem can be repaired in a timely manner. Oftentimes, there are problems with one or more of the interfaces of the computers or digital systems with the LAN. This requires the rerouting of the data using a different path. It is also common to have excessive traffic on the LAN in whole or in part. This may cause increased overhead due to the re-transmitting of lost or destroyed messages.

In prior art systems, such as the 10BASE-T standard type networks, LAN jacks are provided for connecting LAN cables, each terminated with a plug, to a printed circuit board. The LAN jacks are usually mounted on the back surface of a server appliance. Indicators have been provided to display information about the activity of each LAN jack. The indicators are often in the form of binary light-emitting diodes (LEDs), usually green and orange. LEDs are basically semiconductor devices that emit visible light when electric current passes through them. The light is not particularly bright, but in most LEDs it is monochromatic, occurring at a single wavelength. Common LEDs indicators include those that indicate collision, transmission and receive activities. In other cases, optional LEDs are also provided to display polarity and other transmission information. Although most prior art systems place these LEDs on the back surface of the device, i.e., near the LAN jacks themselves, some prior art systems place the LEDs on the front surface so that they may be easily viewed by the user. These LEDs indicators provide a low-cost solution that has low power requirement and long life expectancy.

However, to users or maintenance personnel, these LEDs, being binary in nature, do not provide “meaningful” information, such as data transfer rate that may be averaged or totaled over a specified period of time. At an instance of time, each of the binary LEDs is either on or off. For example, a binary LED transmission indicator merely displays the presence and absence of an active LAN connection, and nothing more. Moreover, monostable devices are usually provided in conjunction with these LEDs to keep the LEDs, or a portion thereof, illuminated for a sufficient time to be seen as a “blink.” The users or maintenance personnel merely observe whether an LED is lit up or not, and at most, observe blinking of the LED. Even if the users or maintenance personnel can somehow determine and estimate the rate of blinking of the LED through visualization, this estimated rate of blinking cannot be accurate and does not translate to meaningful results. Neither the LED being lit up nor the rate of LED blinking allows the users or maintenance personnel to ascertain the rate of data transfer. As discussed, monostable devices, or their equivalents, are provided to extend the time of illumination of the LEDs because direct illumination by transitions of binary signals would not have a time sufficient for the human eye to detect it. Thus, there is no association between the rate of LED blinking and the rate of data transfer. Although the users or maintenance personnel are able to tell whether a LAN connection is active or not through a corresponding LED, the information is not very meaningful otherwise. Therefore, there is a need for a system and method that monitors and provides information about LAN connection status in a more meaningful fashion.

### BRIEF DESCRIPTION OF THE DRAWINGS

The accompanying drawings, which are incorporated in and form a part of this specification, illustrate embodiments of the present invention and, together with the description, serve to explain the principles of the present invention:

FIG. 1 illustrates a perspective view of a monitoring system that shows its rear portion according to an embodiment of the present invention;

FIG. 2 illustrates a perspective view of a monitoring system that shows its front portion according to an embodiment of the present invention;

FIG. 3 illustrates a frontal view of a monitoring system according to an embodiment of the present invention;

FIG. 4 illustrates a side view of the inside of a monitoring system having circuit boards and interconnectors connecting them according to an embodiment of the present invention;

FIG. 5 illustrates a first interconnector that connects a motherboard with a first supplemental card portion positioned above the motherboard according to an embodiment of the present invention;

FIG. 6 illustrates a second interconnector that connects a first supplemental card portion with a second supplemental card portion positioned above the first supplemental card portion according to an embodiment of the present invention;

FIG. 7 illustrates a second supplemental card portion that provides the LAN connection terminals according to an embodiment of the present invention; and

FIG. 8 illustrates a block diagram showing the internal data flow inside a monitoring system according to an embodiment of the present invention.

### DETAILED DESCRIPTION

Reference will now be made in detail to the preferred embodiments of the invention, examples of which are illustrated in the accompanying drawings. While the present invention will be described in conjunction with the preferred embodiments, it will be understood that they are not intended to limit the invention to these embodiments. On the contrary, the present invention is intended to cover alternatives, modifications and equivalents, which may be included within the spirit and scope of the invention as defined by the appended claims. Moreover, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components and circuits have not been described in detail as not to unnecessarily obscure aspects of the present invention.

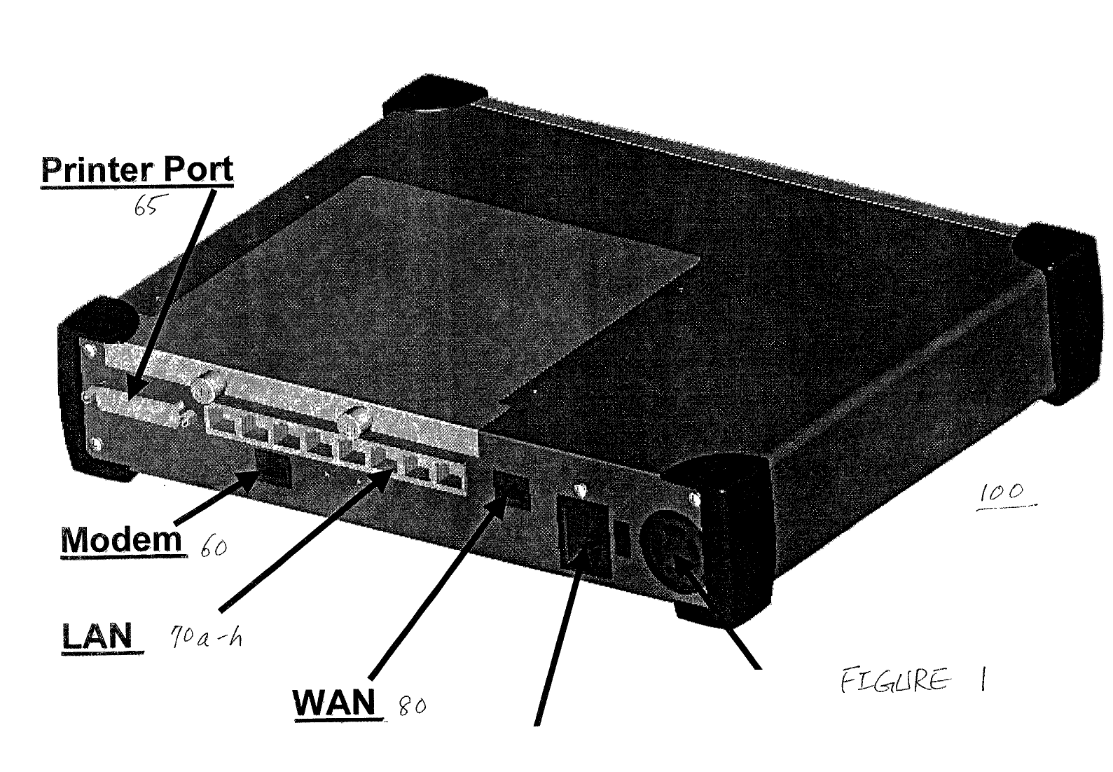

With reference now to FIG. 1, it illustrates a perspective view of a monitoring system showing its rear portion in accordance with an embodiment of the present invention. In a preferred embodiment, the monitoring system is in the form of a server system or server appliance 100 that combines the various functions of a server, router, hub, proxy and firewall. In other embodiments, the monitoring system has a simpler implementation and fewer functions. The server appliance 100 allows, for example, Internet gateway, print sharing, file sharing, firewall, Internet caching and networking. Some of the features of the server appliance 100 include a built-in LAN, LCD interface and remote manageability. Various connection terminals are provided on the backside of the server appliance 100. For example, a modem terminal 60, LAN connection terminals 70a-70h and a wide area network (WAN) 80 connection terminal are provided. These terminals are often referred to as modem port, LAN switch ports and WAN ports. In addition, a printer port 65 is also provided on the backside of the server appliance 100. Although only one modem terminal, eight LAN connection terminals, one WAN connection terminal and one printer port are illustrated in FIG. 1, a different number of terminals may be provided in other embodiments through adding new terminals or using expansion devices.

As shown in FIG. 1, the LAN connection terminals 70a-70h are modular jacks that allow telephone-type plugs, designated as “RJ45” in the industry, to be inserted. Each of the LAN connection terminals 70a-70h allows a connection to be established between a LAN cable terminated with a plug and a printed circuit board residing in the server appliance 100. When the LAN cable is plugged into one of the LAN connection terminals 70a-70h, the server appliance 100 is connected with a workstation or other digital device connected on the other end of the LAN cable. While the LAN connection terminals 70a-70h are mounted on the back surface of the server appliance 100 in the embodiment shown in FIG. 1, they may be mounted on a different surface of the server appliance 100 in another embodiment.

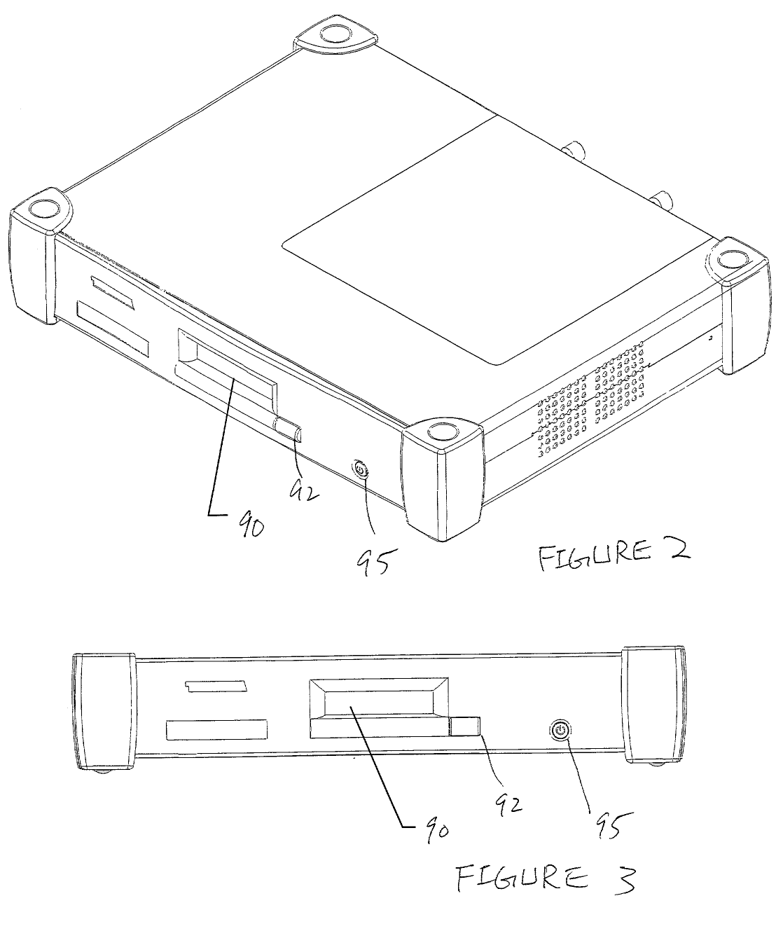

FIG. 2 shows a perspective view of a monitoring system, in the form of a server appliance 100, showing its front portion according to an embodiment of the present invention. Provided on the front surface of the server appliance 100 are, among others, a display 90 in the form of a liquid crystal display (LCD) panel, an adjusting unit 92 in the form of a status scroll button, and an on/off bottom 95 that controls power to the server appliance 100. FIG. 3 illustrates a frontal view of the server appliance 100 shown in FIG. 2. FIG. 3 also shows the LCD panel 90, the status scroll button 92 and the on/off bottom 95. LCD technology is used in the preferred embodiment because it has several advantages over the other kind of displays. For example, the LCD technology allows the display to be much thinner than cathode ray tube technology. LCDs also consume much less power than LED and gas-plasma displays because LCD technology works on the principle of blocking light rather than emitting it. Even though an LCD panel is the preferred type of display, other types of displays may be employed in other embodiments.

The LCD panel 90 can come in various sizes, a typical one being a 2×16 character LCD panel with back-light. The LCD panel 90 may also be made with either a passive matrix or an active matrix display grid. The active matrix LCD is also known as a thin film transistor (TFT) display. The passive matrix LCD has a grid of conductors with pixels located at each intersection in the grid. A current is sent across two conductors on the grid to control the light for any pixel. An active matrix has a transistor located at each pixel intersection, requiring less current to control the luminance of a pixel. In the context of residing on a server appliance, the LCD panel 90 provides many great features. The functions of LCD panel 90 include providing indication that the server appliance 100 is turned on, providing the only access to public and private network IP addresses, providing date, time, status, information from various modules and providing auxiliary information such as news and stock quotes. One of the features on the LCD panel 90 in providing status and information from various modules is the ability for the LCD panel 90 to display the connection status of each LAN connection terminal 70a-70h. For example, the LAN connection data transfer rate and activity may be displayed on the LCD panel 90.

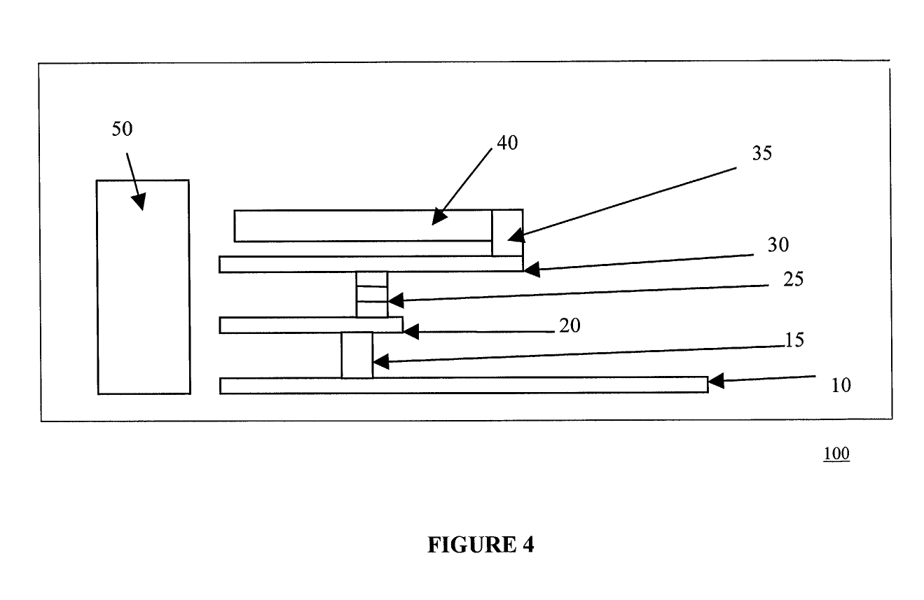

The description will now shift to the internal structures of the monitoring system 100, with the description of how the internal structures work with the LAN connection terminals 70a-70h and the LCD panel 90 to effectively display the LAN connection status to follow. FIG. 4 illustrates a side view of the side of a monitoring system 100 having circuit boards and interconnectors connecting them according to an embodiment of the present invention. The circuit boards, as referred herein, are flat pieces of nonconductive thin plate on which computer microprocessors and other electronic components are placed and electrically connected by thin strips of metal. The circuit boards may, for example, be a motherboard, supplemental card portions, expansion boards and adapters. The supplemental card portion may, for example, be mezzanine cards or daughter cards that are mounted to the main circuit card, such as a motherboard. In one embodiment, the monitoring system 100 includes a motherboard 10, a daughter card 20 and a mezzanine board 30. The three circuit boards are stack mounted, each of which being in parallel with each other. In the stack, the circuit boards have vertical separations between them. The separations between the three circuit boards are created by interconnectors 15, 25 that electrically connect any of the two circuit boards together. In the configuration shown in FIG. 4, the interconnectors 15, 25 are perpendicular to the circuit boards.

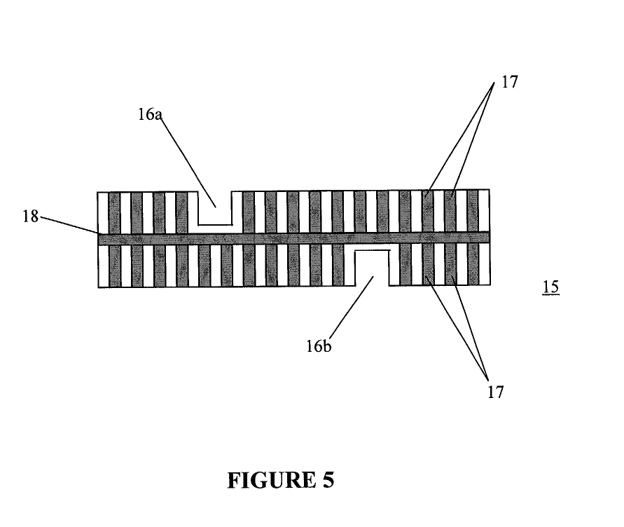

FIG. 5 is an illustrative example of the interconnector 15 that connects a motherboard with a supplemental card portion positioned above the motherboard according to an embodiment of the present invention. In this case, the supplemental card portion is the daughter card 20, and the interconnector 15 electronically connects the daughter card 20 with the motherboard 10. In one implementation, the interconnector 15 is a Peripheral Component Interconnect (PCI) slot extender card. Provided on the top surface of the motherboard 10 is a connective region in the form of a PCI slot. The bottom surface of the daughter card 20 also has a connective region in the form of a PCI slot. The PCI slot extender card 15 fits vertically into the PCI slot connective regions on the top surface of the motherboard 10 and the bottom surface of the daughter card 20. In one implementation, the PCI slot extender card 15 has a notch on each side. The notch on each side matches a locking feature on the corresponding PCI slot, allowing the PCI slot extender card 15 to be properly inserted into the PCI slots. For example, the notch 16a matches the locking feature on the PCI slot located on the bottom surface of the daughter card 20. The notch 16b matches the locking feature on the PCI slot located on the top surface of the motherboard 10. The conductors 17 for each side of the PCI slot extender card 15 is connected to a central bridge 18 that forms a strip down the center of the PCI slot extender card 15. This electrically connects pins 17 from one side with pins 17 from the other side. In other embodiments, the bridge is designed to accommodate any desire scheme for interconnecting pins on either side of the PCI slot extender card 15.

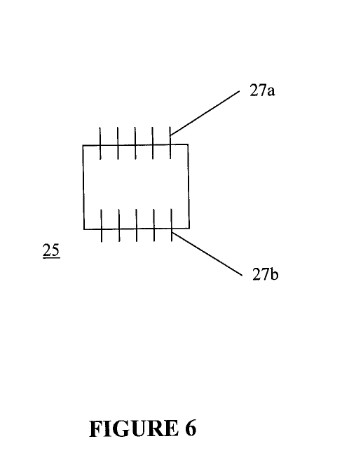

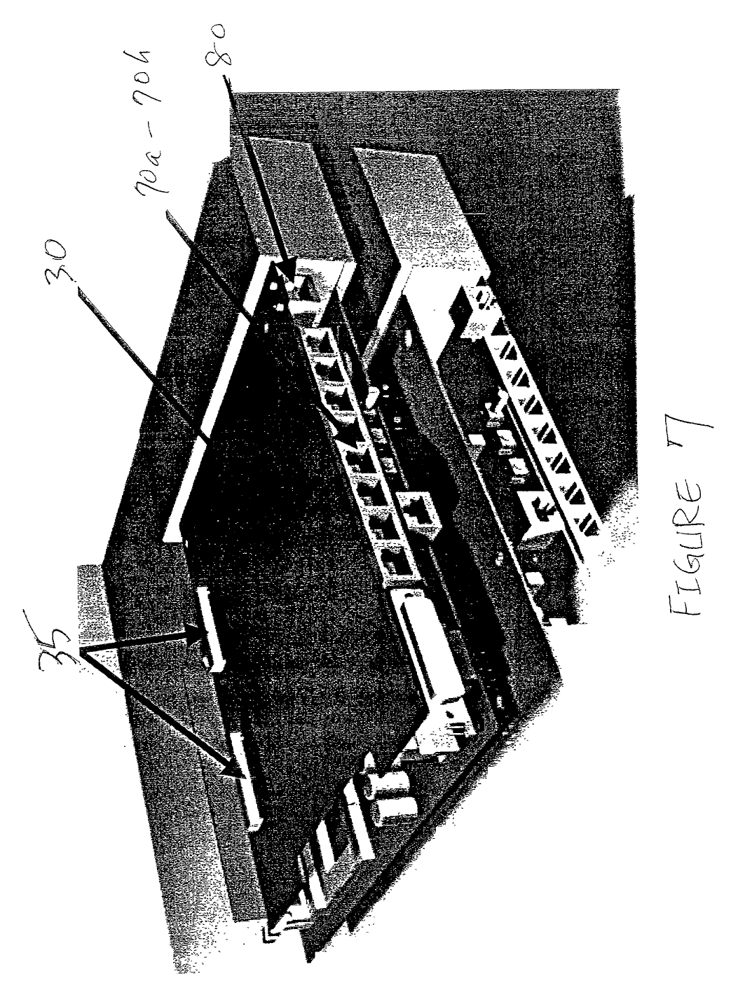

FIG. 6 illustrates an example of the interconnector 25 that connects a supplemental card portion with another supplemental card portion positioned in parallel with each other according to an embodiment of the present invention. In this case, one of the supplemental card portion is the daughter card 20 and the other supplemental card portion is the mezzanine board 30. The interconnector 25 connects the mezzanine board 30 with the daughter card 20. In this example, the interconnector 25 is a male-male connector, i.e., a connector having conductive pins 27a, 27b protruding and exposed from both faces. Provided on the top surface of the daughter card 20 is a connective region in the form of a female connector, which contains holes in which a male connector can be inserted. The bottom surface of the mezzanine board 30 also has a connective region in the form of a female connector. The interconnector 25 electrically connects the female connector mounted on the bottom surface of the mezzanine board 30 with the female connector mounted on the top surface of the daughter card 20. In another implementation, the male-male interconnector 25 is the same type of connector that is typically mounted on a circuit board as a male connector. That is, the interconnector 25 is integrated with and mounted on the daughter card 20, forming a male connector 25. When the interconnector is mounted on a circuit board, however, one set of conductive pins is generally trimmed so as not to protrude through the back surface of the circuit board. In this case, since the male connector 25 is mounted on the daughter card 20, pins 27b on the bottom side of the male-male connector shown in FIG. 3 are trimmed. The male connector 25 has exposed pins on the side opposite to the side being mounted on the daughter card 20. The exposed pins are inserted into the holes of the female connector on the mezzanine board 30. In another embodiment, the location of the male connector 25 and the female connector is reversed. The male connector is integrated with and mounted on the mezzanine board 30, while the female connector is mounted on the daughter card 20.

In one embodiment, a storage drive 40, in the form of a hard disk drive (HDD), is further mounted over the backside of the mezzanine board 30 through an HDD connector 35. The HDD connector 35 may, for example, be a pin connector. As represented in the embodiment in FIG. 1, the backside of the mezzanine board 30 is the top surface of the mezzanine board 30 because the mezzanine board 30 is attached in reverse, wherein most of the circuitry and components attached thereto are on the bottom surface of the mezzanine board 30 and away from the HDD 40. The HDD 40 is connected in such a fashion that makes it in parallel with the mezzanine board 30 (and thus in parallel with the motherboard 10 and the daughter card 20 as well). The HDD connector 35 is vertically positioned, so that a small gap clearance or vertical separation (as shown in FIG. 1) separates the bottom surface of the HDD 40 or a cage (not shown) storing the HDD 40 and the mezzanine board 30, or other partition. This allows heat generated by the HDD 40 to be transferred to the surrounding air without being transferred through the mezzanine board 30 (or other partition), or vice versa into the HDD 40 from the circuitry and components on the mezzanine board 30 (or other partition).

In the embodiment, a cooling fan 50 is provided to the left of the circuit boards 10, 20, 30 and the storage drive 40. In other embodiments, a plurality of cooling fans or other conventional airflow producing means is used to provide convective cooling. The cooling fan 50 does not necessary have to be positioned left to the circuit boards 10, 20, 30. It may be placed in other positions, as long as it is positioned vertically to the circuit boards 10, 20, 30 so as to provide a stream of airflow through the vertical separations and across the top and bottom surfaces of the circuit boards 10, 20, 30. In FIG. 4, airflow from the cooling fan 50 passes across the five surfaces that require cooling: (a) the top surface of the motherboard 10, (b) the top surface of the daughter card 20, (c) the bottom surface (i.e., frontside) of the mezzanine card, (d) the top surface of the HDD 40 and (e) the bottom surface of the HDD 40. These surfaces require cooling because heat is produced from them during the operation of the monitoring system 100. Most of the circuitry and electronic components on the circuit boards 10, 20, 30 are located on the top surface of the motherboard 10, the top surface of the daughter card 20 and the bottom surface of the mezzanine card 30, respectively. During operation, the circuitry and electronic components can produce intense heat if no air circulation is provided. Moreover, operations of the HDD 40 involve rapid mechanical movements, which also produce heat.

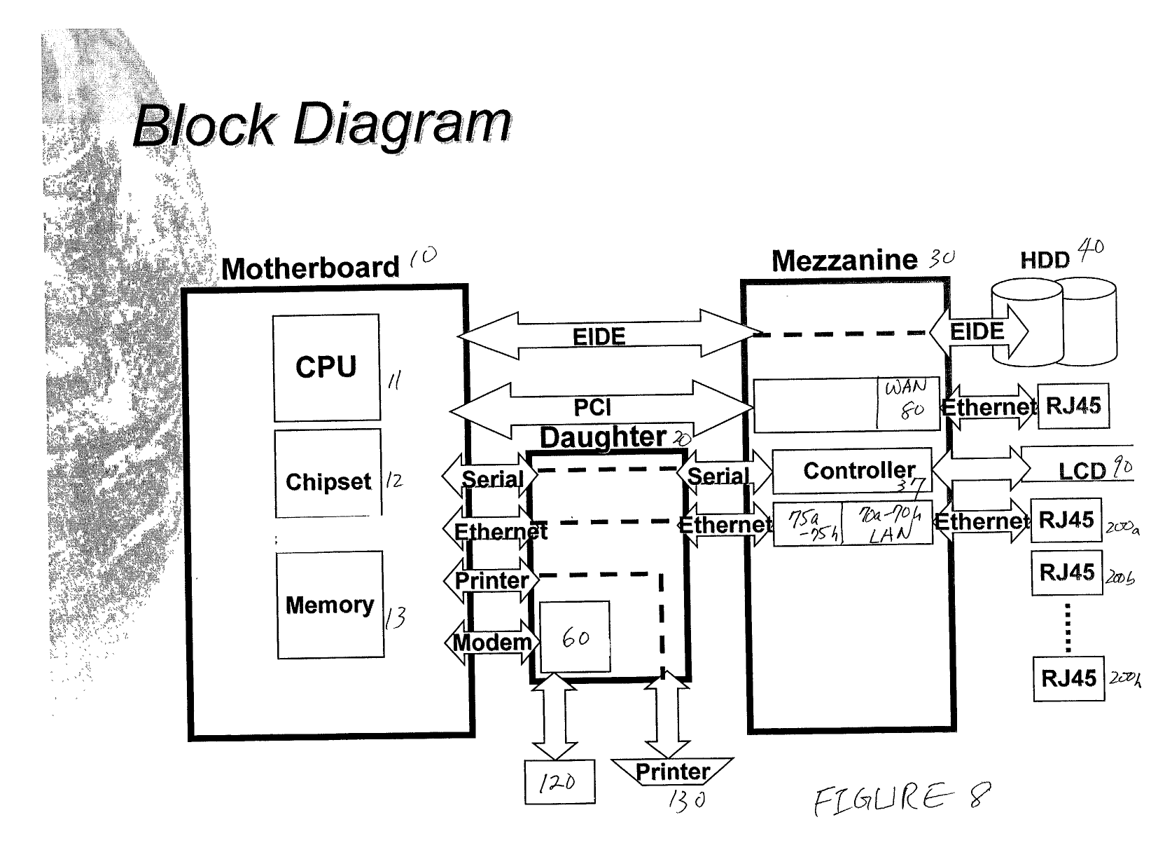

FIG. 7 illustrates the mezzanine board 30 connected to the motherboard 10 via the interconnector 25 according to an embodiment of the present invention. Through the interconnectors 15, 25, the mezzanine board 30 has the ability to access the motherboard components, such as memory and CPU, directly instead of sending data through the slower expansion bus. In addition, the mezzanine board 30 provides additional connectors and additional I/O pins to the motherboard 10. As illustrated in FIG. 7, the mezzanine board 30 includes controllers (not shown), a HDD connector 35, LAN connection terminal 70a-70h, and a WAN connection terminal 80. The LAN connection terminals 70a-70h are utilized for computers/workstations that are geographically close together. The WAN connection terminal 80 is utilized for computers/computer systems that are farther apart and are connected by, for example, telephone lines or radio waves. While the description so far has directed only to the display of LAN connection status, those skill in the art should readily recognize and appreciate that activity detection and display on a LCD panel may be carried out for other connection terminals, such as the modem terminal 60 and the WAN connection terminal 80.

FIG. 8 illustrates a block diagram showing the internal flow of data among the motherboard 10, the daughter card 20, the mezzanine board 30, the HDD 40, the LCD panel 90, and other workstations. The motherboard 10 is the main circuit board and provides the main computing capability of the server appliance. The motherboard 10 may, for example, include a central processing unit (CPU) 11, a chipset 12 and memory 13. The daughter card 20 is a circuit board that plugs into another circuit board. As shown here, the daughter card provides modem terminal 60 for connection to a standard phone line 120 and printer port (not shown) for connection to a printer 130. Several connections can be made between the motherboard 10 and the daughter card 20, e.g., serial connection, Ethernet connection, printer connection and modem connection. As shown in FIG. 8, the mezzanine board 30 contains integral components that interact with the HDD 40, the LCD panel 90 and external workstations (through the Ethernet and RJ45 plugs). While a serial connection and an Ethernet connection may be established between the mezzanine board 30 and the daughter card 20, a PCI connection and an enhanced integrated drive electronics (EIDE) connection may be established directly between the mezzanine board 30 and the motherboard 10. An EIDE connection is established between the mezzanine board 30 and the HDD 40, and Ethernet connections are established between the mezzanine board 30 and the external workstations.

As shown in FIG. 8, the mezzanine board 30 includes a WAN connection terminal 80, a display controller 37, LAN connection terminals 70a-70h and signal detection devices 75a-75h. Each signal detection devices 75a-75h corresponds to a LAN connection terminal. In operation, a number of cables are provided to connect external workstations with the server appliance 100 via the RJ45 200a-200h at the workstations end and LAN connection terminals 70a-70h at the server appliance 100 end. For simplicity, only a workstation, the LAN connection terminal 70a and a cable connecting the two are described below. The cable may, for example, contain wires associated with transmit, receive, and/or collision activity data transmission. Upon receiving a signal or data at the LAN connection terminal 70a or before transmitting a signal or data from the LAN connection terminal 70b, the signal is detected by a detecting device 75a that corresponds to the LAN connection terminal 70a. In one implementation, the detecting device 75a is a logic block comprises circuit components, such as transistors, resistors and capacitors. The transistors are pre-biased to allow it to switch from high to low with minimal signal voltage presence, providing an indication of activity in the cable. The logic block looks for the transient of energy states that is present when at least one wire in the cable moves from an inactive “low” or “0” state to an active “high” or “1” state. The “low” state indicates a lack of activity on the line, while the “high” state indicates the presence of activity and signals/data moving in the cable. In this implementation, the transient of energy states provides a signal voltage that adds to a voltage biasing of a transistor, switching it from high to low and providing an indication of activity in the cable. In other implementations, the detecting device 75a may be embodied in a controller-like or processor-like device, where additional information other than the activity of the wires in the cable can be ascertained easily. For example, the detecting device 75a may exam the actual data content of the signal by examining packet headers of the data to distinguish between different types of transmission and/or data. In this case, the signal may be sent from the LAN connection terminal 70a to the controller-like or processor-like device via wiring.

Once such transition is realized, the information is sent to the display controller 37. The information may be sent from the LAN terminal connections 70a to the display controller 37 via wiring. In one implementation, the information may be displayed in a binary fashion, mimicking what the LEDs would do, or it may be manipulated by the display controller 37 or a second controller on the mezzanine board 30 to provide more useful information to the user. In other implementations, the information may also be provided to CPU or chipset on the motherboard to be further processed for display. For example, the data transfer rate information of the connection terminal 70a may be averaged or totaled over a specific period of time to give a user some ideal of the traffic through a particular LAN connection terminal. The present invention may also distinguish between the polarity of the data transfer, assigning a positive value for data flowing from the monitoring system to external workstations and a negative value for data flowing from external workstations into the monitoring system. An average or total can be obtained with the polarity in mind. In addition, overall activity and average activity, including the transmission activity, receiving activity and collision activity, may also be summarized. The type of data running through the cable can also be categorized. The same analysis can be performed for the WAN connection terminal 80 and the modem terminal 60.

In embodiments of the invention, the data transfer rate and the activity information may be continually displayed in a dedicated portion of the LCD panel 90. In other embodiments of the invention, the display controller 37 may display information according to several menus, one of which may be a diagnostic menu. In such an embodiment, the LAN connection status and information is displayed on the LCD panel 90 only when the display controller 37 is displaying information according to the diagnostic menu. In one implementation, the displaying of the LAN connection information may be a default setting for the LCD panel 90. The LCD panel 90 assists in monitoring the LAN connection status and troubleshooting the LAN connections. More meaningful results, such as the data transfer rate, are achieved through the LCD panel 90.

While the foregoing description refers to particular embodiments of the present invention, it will be understood that the particular embodiments have been presented for purposes of illustration and description. They are not intended to be exhaustive or to limit the invention to the precise forms disclosed. Many modifications and variations are possible in light of the above teachings and may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A LAN connection monitoring system, comprising:
a plurality of LAN connection terminals for connecting the monitoring system to a plurality of computer systems, transmitting binary signals between the monitoring system and the computer systems;
a display for displaying activity information of LAN connection terminals;
signal detection means connected to each of the LAN connection terminals for detecting any binary signal transmission at each of the LAN connection terminals;
calculating means for calculating a transfer rate of the binary signal transmission at a LAN connection terminal;
signal relaying means for relaying the detected binary signal transmission to the calculating means; and
displaying means for displaying the calculated transfer rate on the display.

2. The LAN connection monitoring system of claim 1, wherein the plurality of LAN connection terminals are modular jacks that utilize telephone-type plugs RJ45.

3. The LAN connection monitoring system of claim 1, wherein the display is a liquid crystal display.

4. The LAN connection monitoring system of claim 3, wherein the displaying means and the calculated means are embodied in a liquid crystal display controller.

5. The LAN connection monitoring system of claim 1, wherein the displaying means and the calculated means are embodied in at least one of a controller type device or a processor type device.

6. The LAN connection monitoring system of claim 1, wherein the transfer rate is averaged over a specified period of time to give activity information pertaining to traffic through a particular LAN connection terminal.

7. The LAN connection monitoring system of claim 1, wherein the transfer rate is totaled over a specified period of time to give activity information pertaining to traffic through a particular LAN connection terminal.

8. The LAN connection monitoring system of claim 1, wherein the displaying means displays the calculated transfer rate continuously in a dedicated portion of the display.

9. The LAN connection monitoring system of claim 1, wherein the displaying means displays the calculated transfer rate in the display only when the displaying means is displaying activity information according to a diagnostic menu, the diagnostic menu being one of the several menus according to which the displaying means may display different information.

10. The LAN connection monitoring system of claim 1, further comprising:
a circuit board having electronic circuits disposed thereon;
a supplemental card portion positioned above and being in parallel with the circuit board; and
an interconnector connecting the circuit board and the supplemental card, the interconnector further providing vertical separation between the circuit board and the supplemental card portion, wherein the plurality of LAN connection terminals, the signal detection means, the calculating means, the signal relaying means and the displaying means are provided on the supplemental card portion.

11. The LAN connection monitoring system of claim 10, wherein the interconnector is a Peripheral Component Interconnect (PCI) slot extender card that connects a PCI slot on the top surface of the circuit board with a PCI slot on the bottom surface of the supplemental card portion.

12. The LAN connection monitoring system of claim 10, wherein the interconnector is a male-male connector having a connection mechanism of providing conductive pins protruding from both sides, the interconnector connecting a female connector mounted on the top surface of the circuit board with a female connector mounted on the bottom surface of the supplemental card portion.

13. The LAN connection monitoring system of claim 10, wherein the interconnector is mounted on the top surface of the circuit board as a male connector, the interconnector connecting the circuit board with the supplemental card portion through a female connector mounted on the bottom surface of the supplemental card portion.

14. A LAN connection monitoring system of claim 1, wherein the LAN connection monitoring system is embodied in a server appliance that integrates the function of a server, a hub and a router.

15. A LAN connection monitoring method, the method comprising:
detecting binary signal transmission at a plurality of LAN connection terminals for connecting a monitoring system to a plurality of computer systems;
relaying the detected binary signal transmission to a processing device;
calculating a transfer rate of the binary signal transmission at a LAN connection terminal; and
displaying the calculated transfer rate on a display.

16. The LAN connection monitoring method of claim 15, wherein the plurality of LAN connection terminals are modular jacks that utilize telephone-type plugs RJ45.

17. The LAN connection monitoring method of claim 15, wherein the display is a liquid crystal display.

18. The LAN connection monitoring method of claim 17, wherein the processing device is a liquid crystal display controller that calculates and displays the transfer rate.

19. The LAN connection monitoring method of claim 15, wherein the transfer rate is averaged over a specified period of time to give activity information pertaining to traffic through a particular LAN connection terminal.

20. The LAN connection monitoring method of claim 15, wherein the transfer rate is totaled over a specified period of time to give activity information pertaining to traffic through a particular LAN connection terminal.

21. The LAN connection monitoring method of claim 15, wherein the calculated transfer rate is shown continuously in a dedicated portion of the display.

22. The LAN connection monitoring method of claim 15, wherein the calculated transfer rate is shown in the display only when the processing device is displaying activity information according to a diagnostic menu, the diagnostic menu being one of the several menus according to which the processing device may display different information.

23. The LAN connection monitoring method of claim 15, further comprising:
providing a circuit board having electronic circuits disposed thereon;
positioning a supplemental card above and in parallel with the circuit board; and
connecting the circuit board with the supplemental card using an interconnector, the interconnector creating vertical separation between the circuit board and the supplemental card portion, wherein the plurality of LAN connection terminals and the processing device for calculating and displaying the transfer rate are provided on the supplemental card portion.

24. The LAN connection monitoring method of claim 23, wherein the interconnector is a Peripheral Component Interconnect (PCI) slot extender card that connects a PCI slot on the top surface of the circuit board with a PCI slot on the bottom surface of the supplemental card portion.

25. The LAN connection monitoring method of claim 23, wherein the interconnector is a male-male connector having a connection mechanism of providing conductive pins protruding from both sides, the interconnector connecting a female connector mounted on the top surface of the circuit board with a female connector mounted on the bottom surface of the supplemental card portion.

26. The LAN connection monitoring method of claim 23, wherein the interconnector is mounted on the top surface of the circuit board as a male connector, the interconnector connecting the circuit board with the supplemental card portion through a female connector mounted on the bottom surface of the supplemental card portion.
